(19) United States
(12) Patent Application Publication
(10) Pub. No.: US 2009/0228338 A1
(43) Pub. Date: Sep. 10, 2009

(54) METHOD FOR MEASURING THE IMPACT OF ADVERTISING ON BRAND PERCEPTION

(76) Inventors: Ruthie Brandman, Oranit (IL); Maurice Brandman, Oranit (IL)

Correspondence Address: DANIEL J SWIRSKY, 55 REUVEN ST., BEIT SHEMESH, 99544, IL

(21) Appl. No.: 12/398,254

(22) Filed: Mar. 5, 2009

Related U.S. Application Data
(60) Provisional application No. 61/064,479, filed on Mar. 7, 2008.

(51) Int. Cl. G06Q 10/00

(52) U.S. Cl. 705/10

(57) ABSTRACT

A method for measuring the impact of advertising on brand perception is provided. The method utilizes a computing device to compare the perception of a brand from respondents who have been exposed to an advertising campaign with a second group of respondents who have not been exposed to the advertising campaign and calculating the percentage of change in the perception of the brand as a result of exposure to the advertising campaign.

### FIELD OF THE INVENTION

The present invention relates to a system and method for measuring and monitoring the effectiveness of advertising. More specifically, the present invention relates to a model system and method for measuring the impact of advertising on the perception of the brand being advertised.

### BACKGROUND OF THE INVENTION

Products and services offered by companies are commonly advertised to increase customer's awareness of a specific product or service. There are many different forms of advertising such as newspapers, billboards and advertising via the internet.

Irrespective of the form of advertising, it is difficult for the advertiser to measure the impact of advertising on the potential customer. It is specifically problematical to isolate the impact of advertising from other factors.

The effectiveness of an advertising message to an audience is important and is generally quantified by the number of people that saw a particular advertisement in a given media.

There are many different methods for determining the effectiveness and efficiency of advertising, for example.

Generally, in order to determine the effectiveness of an advertising campaign, it is necessary to conduct two surveys—one survey before the campaign and one after the campaign—and compare results. Other existing models require a simulation in laboratory or a tested region or channel in order to analyze the effects of the advertisement.

Furthermore, existing methods are prone to errors since they do not accurately gauge the net impact of the advertising unaffected by other factors. They do not isolate the actual exposure to the given campaign from exposure to other campaigns of the brands or the competition

A need, therefore, exists for providing a system and a method for monitoring and measuring the effectiveness of advertising that isolates the impact of advertising from other factors.

### SUMMARY OF THE INVENTION

The present invention relates to a model that isolates the impact of advertising from other factors, after the advertising has been aired in real life.

The objective of the model may be summarized as follows:
To measure the scope of change that the advertising has created in the perception of the brand in the target audience. The change can be positive or negative and is presented as a percentage of total target market.
To measure this separately for each attribute.
To isolate other interfering biases and factors, including other campaigns, marketing tools and respondents' biases.

There is thus provided, a method for measuring the impact of advertising on brand perception. The method utilizes a computing device to perform the steps of comparing the perception of a brand from a first plurality of respondents who have been exposed to an advertising campaign with a second plurality of respondents who have not been exposed to the advertising campaign; and calculating the percentage of change in the perception of the brand as a result of exposure to the advertising campaign.

Furthermore, the step of comparing includes the step of conducting a survey on a representative sample of a target audience, the survey being conducted during or immediately after the advertising campaign. The target audience includes the first and second plurality of respondents.

Furthermore, the step of comparing further includes the steps of defining a statistic set; for the first plurality of respondents, compiling a first total the number of respondents who meet the criteria of the defined statistic set and who have seen the advertisement and compiling a second total of the number of respondents who do not meet the criteria of the defined statistic set and who have seen the advertisement; and for the second plurality of respondents, compiling a third total of the number of respondents who meet the criteria of the defined statistic set and who have not seen the advertisement and compiling a fourth total of the number of respondents who do not meet the criteria of the defined statistic set and who have not seen the advertisement. The statistic set may include one of a group including brand users, gender, age and social strata.

Furthermore, the step of comparing the perception of a brand further includes the step of applying an attitudinal scale to the perception of the brand for each of the respondents in each of the first and second plurality of respondents.

Furthermore, the method may include the steps of conducting a study of a multiplicity of respondents on a plurality of advertising campaigns; establishing the respondent's perception of each of a plurality of brands advertised in the plurality of advertising campaigns; and formulating a set of constant biases based on the respondent's perception of each of the brands advertised.

Furthermore, the step of calculating the percentage of change includes the steps of calculating the expected perception of the first plurality of respondents who have been exposed to the advertising campaign; calculating the total perception of the brand based on the calculated expected perception of the first plurality of respondents plus the observed perception of the second plurality of respondents who were not exposed to the advertising campaign; and calculating the relationship between the expected and the observed results, thereby to derive the percentage of change in the perception of the brand.

Furthermore, the step of calculating expected perception includes the steps of calculating the expected perception of the first plurality of respondents who have been exposed to the advertising campaign based on the observed perception of persons who did not see the advertisement; and applying at least one of set of constant biases to the expected perception of the first plurality of respondents who have been exposed to the advertising campaign.

Furthermore, the percentage of change in the perception of the brand as a result of exposure to the advertising campaign may then be calculated, in accordance with the following equation:

$$\% Change = \frac{{\sum }^{ } ( A , B , C , D ) - {\sum }^{ } ( A 2 , B , C 2 , D )}{{\sum }^{ } ( A 2 , B , C 2 , D )}$$

where: A=observed perception of respondents who meet the criteria of the defined statistic set and who have seen the advertising campaign; B=observed perception of respondents who meet the criteria of the defined statistic set who have not seen the advertising campaign; C=observed perception of respondents who do not meet the criteria of the defined statistic set and who have seen the advertising campaign; and D=observed perception of respondents who do not meet the criteria of the defined statistic set and who have not seen the advertising campaign; and

where A2=expected perception of respondents who meet the criteria of the defined statistic set and who have seen the advertising campaign; and C2=expected perception of respondents who do not meet the criteria of the defined statistic set and who have seen the advertising campaign.

In addition, there is also provided, a method for formulating a set of constant biases. The method includes utilizing a computing device to perform the steps of conducting a study of a multiplicity of respondents on a plurality of advertising campaigns; and for each of the plurality of advertising campaigns,

measuring the respondent's perception of the brand being advertised;

comparing the perception of respondents who have been exposed to the advertising campaign with respondents who have not been exposed to the advertising campaign; and

calculating the relationship between the respondents who have been exposed to the advertising campaign with respondents who have not been exposed to the advertising campaign; thereby to determine the constant bias for each of the plurality of advertising campaigns.

Furthermore, the step of comparing includes the step of applying an attitudinal scale to the brand being advertised for each of the respondents.

### BRIEF DESCRIPTION OF THE DRAWINGS

The present invention will be understood and appreciated more fully from the following description taken in conjunction with the appended drawings in which:

FIG. 1 is a schematic flow chart illustration of the method for measuring the impact of an advertising campaign on a sample of respondents, in accordance with an embodiment of the present invention; and

FIG. 2 is a schematic flow chart illustration of the model for analyzing the results of the research survey used with the method of FIG. 1.

### DESCRIPTION OF THE INVENTION

The present invention relates to a model and method for measuring the impact of advertising on the interviewees' perceptions of the brand which is the subject of an advertising campaign.

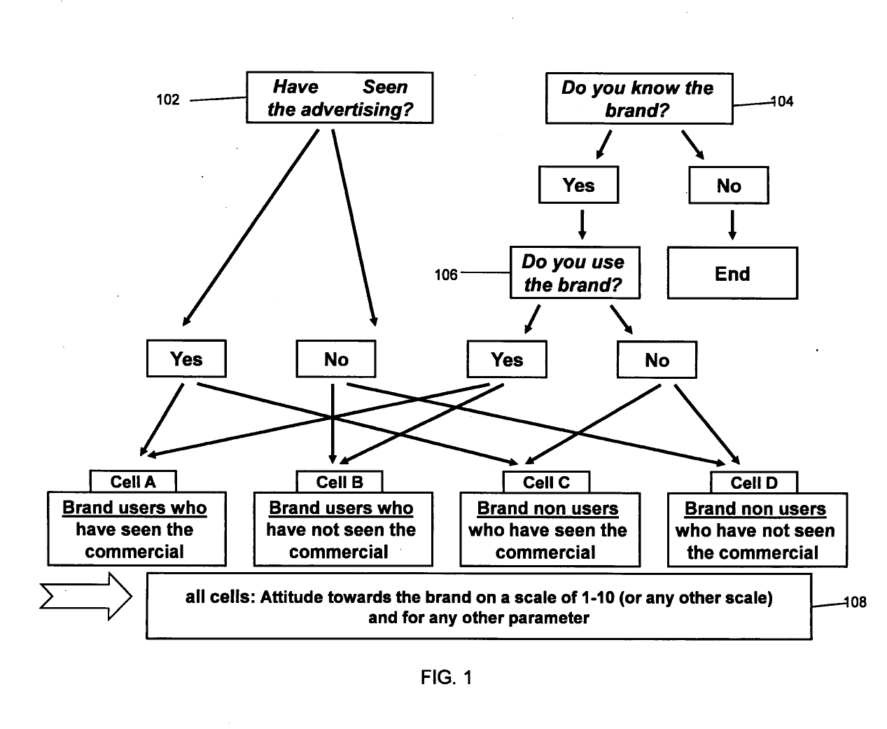

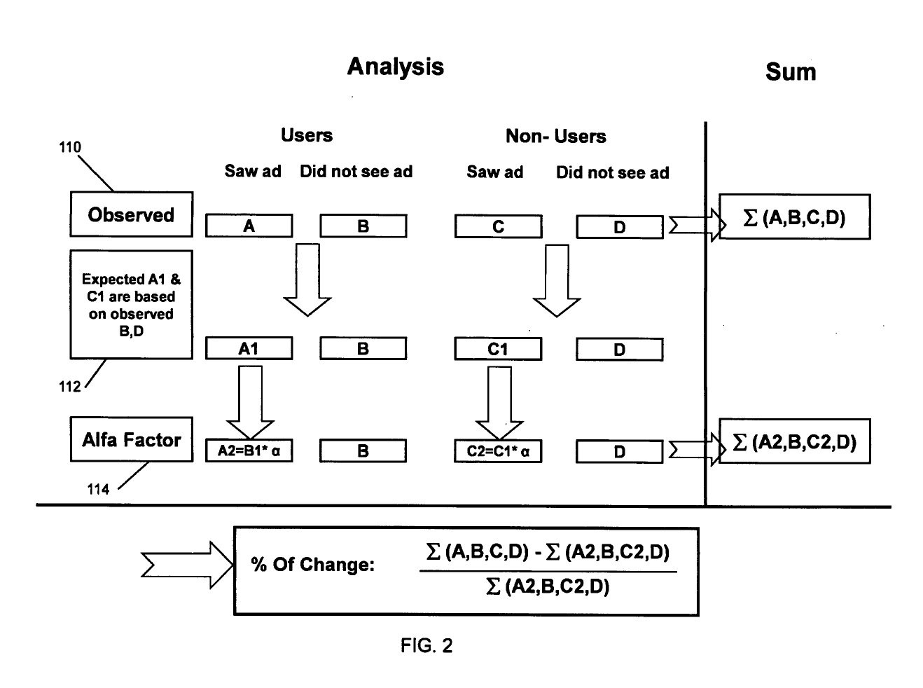

Reference is now made to FIGS. 1 and 2. FIG. 1 is a schematic flow chart illustration of the method for measuring the impact of advertising on brand perception, in accordance with an embodiment of the present invention. FIG. 2 is a schematic flow chart illustration of the analytical model for analyzing the results of the research survey.

### The Model

The model is based on two key elements:
A research survey on a representative sample of the target audience which is conducted during or immediately after the advertising campaign.
A study conducted among 10,286 respondents and measuring 620 campaigns which was used to formulate the “Alfa Factor” which is required for the formula. The “Alfa” factor is a set of constant biases which affect the results.

The model takes into account the bias caused by the respondents. The inventors have realized that respondents who are exposed to an advertising campaign have a different perception of the brand being advertised from those who are not exposed to it. Furthermore, there are other variables which affect the users' perception. For example, users of a brand have a different attitude toward the brand than non-users. There are many other variables which affect perception, such as—but not limited to—gender (male/female), age and social strata, for example. The model identifies which single variable or group of variables are most significant in defining attitude and which should be used to measure the impact of the advertising campaign. For the purposes of example, this variable is hereinafter referred to as the ‘statistic set’. The term ‘non-statistic set’ is used to define persons excluded from the ‘statistic set’. Thus, ‘statistic set’/‘non-statistic set’ may refer to “brand users” versus “brand non-users” or “age group 20-30” versus “age group above 30”, for example.

Thus, there are four separate groups, which may have different perceptions of a brand, as follows:
cell A. ‘statistic set’ that have seen the advertising campaign;
cell B. ‘statistic set’ that have not seen the advertising campaign;
cell C. ‘non-statistic set’ who have seen the advertising campaign; and
cell D. ‘non-statistic set’ that have not seen the advertising campaign.

The impact of the advertising campaign may be measured in a single survey after it has been aired in real life by analyzing the four groups of respondents. The model isolates the respondents' actual exposure to a specific campaign.

The expected perception for persons who have seen the advertisement may be determined by applying a bias constant to the observed results. For the purposes of this example, the bias constant is referred to as the “Alfa” factor.

### Research Tools

Different research tools may be used. In an embodiment of the invention, the following non-limiting examples may be utilized in the survey:

1. Perception of the Brand
This perception of the brand may be measured by any type of attitudinal scale.

For example, the interviewee may be requested to “rate his/her overall attitude” toward brand “X” on a scale of 1-10, where 10 means “very positive” and 1 means “very negative”. This method may be applied for various variables for brands, companies and persons. Any other type of scale or tool known in the art, which measures attitude may be used.

2. Exposure to the Commercial
In order to determine whether the interviewee has seen the campaign, a description of the commercial may be read to the interviewees—without mentioning the brand or company name—and the interviewees are asked to confirm if they recognize the brand. If the answer is positive, they are then requested to name the brand the campaign is advertising. Other formats for testing brand exposure, known in the art, may also be utilized.

3. Brand Usage
To determine whether they are brand users, interviewees may be asked to specify if they use this brand regularly, occasionally or not at all.

Reference is now made to FIG. 1, which is a schematic flow chart illustration of the method for researching the impact of an advertising campaign on a sample of respondents. For the purposes of example only and for clarity, a single variable of “brand users” versus “brand non-users” is used to define the ‘statistic set’/‘non-statistic set’.

The interviewees are asked questions regarding their exposure to the advertising campaign and their use of the brand.

The interviewee is asked whether he has seen the advertisement (query box 102). The interviewee is then asked whether he is familiar with the brand (query box 104). If the response is negative, the response is not relevant to the survey.

If the response is positive, the interviewee is asked whether he uses the brand (query box 106).

Each respondent giving a relevant response (that is, an interviewee knows the brand) is also asked to rate his/her overall attitude toward the advertised brand on a scale of 1-10, where say, 10 means “very positive” and 1 means “very negative” (108).

The responses to the survey are distributed between the four cells A, B, C, and D, according to the interviewees answers, as follows:
cell A. brand users (‘statistic set’) who have seen the commercial;
   respondents who have answered “YES” to questions 102, 104 and 106.
cell B. brand users who have not seen the commercial;
   respondents who have answered “NO” to question 102 and “YES” to questions 104 and 106.
cell C. brand non-users (‘non-statistic set’) who have seen the commercial;
   respondents who have answered “YES” to questions 102, and 104 but “NO” to question 106.
cell D. brand non users who have not seen the commercial respondents who have answered “YES” to question 104 but “NO” to questions 102 and 106.

### The Change Calculation

The present invention measures the change impacted by exposure to the advertising campaign. Reference is now made to FIG. 2, which is a schematic flow chart illustration of the model for analyzing the results of the research survey. The calculation steps are as follows:
Step 1: The observed perception (line 110) for users (cells A and B) and non-users (cells C and D) of the advertised brand is calculated as follows:

Σ(A, B, C, D)
Step 2: The expected perception (line 112) for persons who saw the advertisement are calculated, based on the observed perception of persons who did not see the advertisement (groups B and D). The expected perceptions are shown as A1 and C1.
Step 3: The constant bias a (or Alfa Factor) is applied to the expected perception of A1 and C1 (line 114) resulting in A2 (=A1*α) and C2 (=C 1* α). The total expected perception may be represented as:

Σ(A2, B, C2,D)
Step 3: The percentage of change in the perception of the brand as a result of exposure to the advertising campaign may then be calculated, as follows:

$$\% Change = \frac{\sum ( A , B , C , D ) - \sum ( A 2 , B , C 2 , D )}{\sum ( A 2 , B , C 2 , D )}$$

### Advantages of the Present Invention

In contrast to prior art applications, the present invention is the only model that measures the impact of advertising in a single survey after it has been aired in real life and not in a simulated or tested region. Prior art models generally need to run two surveys and compare results, with one survey before the campaign and one after the campaign. Other existing models require a simulation in laboratory or a tested region or channel in order for analysis.

Furthermore, the model of the present invention isolates the change impacted by actual proven exposure to advertising, in contrast to “before-after” model that assumes exposure in the period between measurements. Other prior art models do not isolate the actual exposure to the given campaign from exposure to other campaigns of the brands or the competition. A further advantage of the present invention over existing models is that this is the only model that is free of any other interfering marketing activities of the brand or its competitors which occurred concurrently with the campaign.

The model of present invention is the only model that takes into account the bias caused by the respondents—The model tests the hypothesis that respondents that are exposed to the campaign have a prior different perception of the brand from those who are not exposed to it. The “Alfa” factor represents this bias constant.

It will be further appreciated that the present invention is not limited by what has been described hereinabove and that numerous modifications, all of which fall within the scope of the present invention, exist. Rather the scope of the invention is defined by the claims, which follow:

What is claimed is:

1. A method for measuring the impact of advertising on brand perception, the method comprising utilizing a computing device to perform the steps of:
comparing the perception of a brand from a first plurality of respondents who have been exposed to an advertising campaign for said brand with a second plurality of respondents who have not been exposed to said advertising campaign; and
calculating the percentage of change in the perception of the brand as a result of exposure to the advertising campaign.

2. The method of claim 1 wherein said step of comparing comprises the step of:
conducting a survey on a representative sample of a target audience, said survey being conducted during or immediately after the advertising campaign; wherein said target audience comprises said first and second plurality of respondents.

3. The method of claim 1 wherein said step of comparing further comprises the steps of:
defining a statistic set;
for said first plurality of respondents, compiling a first total the number of respondents who meet the criteria of the defined statistic set and who have seen the advertisement and compiling a second total of the number of respondents who do not meet the criteria of the defined statistic set and who have seen the advertisement; and
for said second plurality of respondents, compiling a third total of the number of respondents who meet the criteria of the defined statistic set and who have not seen the advertisement and compiling a fourth total of the number of respondents who do not meet the criteria of the defined statistic set and who have not seen the advertisement.

4. The method of claim 3, wherein the statistic set comprises one of a group including brand users, gender, age and social strata.

5. The method of claim 3, wherein the step of comparing the perception of a brand further comprises the step of:
for each of the respondents in each of said first and second plurality of respondents; applying an attitudinal scale to the perception of the brand.

6. The method of claim 1 further comprising the steps of:
conducting a study of a multiplicity of respondents on a plurality of advertising campaigns;
establishing the respondent's perception of each of a plurality of brands advertised in said plurality of advertising campaigns; and
formulating a set of constant biases based on the respondent's perception of each of the brands advertised.

7. The method of claim 6 wherein said step of calculating the percentage of change comprises the steps of:
calculating the expected perception of the first plurality of respondents who has been exposed to said advertising campaign;
calculating the total perception of the brand based on said calculated expected perception of the first plurality of respondents plus the observed perception of the second plurality of respondents who were not exposed to said advertising campaign; and
calculating the relationship between the expected and the observed results, thereby to derive the percentage of change in the perception of the brand.

8. The method of claim 7 wherein said step of calculating expected perception comprises the steps of:
calculating the expected perception of the first plurality of respondents who have been exposed to said advertising campaign based on the observed perception of persons who did not see the advertisement; and
applying at least one of set of constant biases to the expected perception of the first plurality of respondents who has been exposed to said advertising campaign.

9. The method of claim 8 wherein the percentage of change in the perception of the brand as a result of exposure to the advertising campaign may then be calculated, as follows:
$$\% Change = \frac{\sum ( A , B , C , D ) - \sum ( A 2 , B , C 2 , D )}{\sum ( A 2 , B , C 2 , D )}$$
where: A=observed perception of respondents who meet the criteria of the defined statistic set and who have seen the advertising campaign; B=observed perception of respondents who meet the criteria of the defined statistic set who have not seen the advertising campaign; C=observed perception of respondents who do not meet the criteria of the defined statistic set and who have seen the advertising campaign;, and D=observed perception of respondents who do not meet the criteria of the defined statistic set and who have not seen the advertising campaign; and
where A2=expected perception of respondents who meet the criteria of the defined statistic set and who have seen the advertising campaign; and
C2=expected perception of respondents who do not meet the criteria of the defined statistic set and who have seen the advertising campaign.

10. A method for formulating a set of constant biases, the method comprising utilizing a computing device to perform the steps of:
conducting a study of a multiplicity of respondents on a plurality of advertising campaigns; and
for each of said plurality of advertising campaigns,
measuring the respondent's perception of the brand being advertised;
comparing the perception of respondents who have been exposed to the advertising campaign with respondents who have not been exposed to the advertising campaign; and
calculating the relationship between the respondents who have been exposed to the advertising campaign with respondents who have not been exposed to the advertising campaign,
thereby to determine the constant bias for each of said plurality of advertising campaigns.

11. The method of claim 10 wherein said step of comparing comprises the step of:
each of the respondents applying an attitudinal scale to the brand being advertised.
